(19) United States
(12) Patent Application Publication
(10) Pub. No.: US 2003/0005592 A1
(43) Pub. Date: Jan. 9, 2003

(54) Level having a light device

(76) Inventor: Chien-Kuo Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/899,140

(22) Filed: Jul. 6, 2001

(51) Int. Cl. G01C 9/00

(52) U.S. Cl. 33/451; 33/286

(57) ABSTRACT

A level includes an elongated body having an open end for receiving a power supply assembly therein. A bubble vial is engaged with a frame which is connected to the body. A light bulb is engaged with an end of the frame and is powered by the light bulb. A switch is connected to an end of power supply assembly and is accessed by a user.

### FIELD OF THE INVENTION

The present invention relates to a level having a light connected beside bubble level vial and a power supply is connected to an end of the body of the level for controlling the light.

### BACKGROUND OF THE INVENTION

A conventional level generally includes an elongated body and a bubble level vial connected to a top surface of the body. The bottom of the body is flat so that when the level is put on a surface, the location of the bubble in the bubble vial tells the surface is horizontal or not. However, the conventional level are not provided with a light or illumination device so that the users have to find a light to see the position of the bubble in the bubble vial when using the level in a dark area. It could not be so convenient to get a light or electrical power when in use so that it is a problem for the users to use the conventional level.

### SUMMARY OF THE INVENTION

In accordance with one aspect of the present invention, there is provided a level which comprises a body having an open end with a power supply assembly engaged therewith. A bubble vial has a frame which is connected to the body and a light bulb is engaged with an end of the frame. The light bulb is electrically connected to the power supply assembly.

The primary object of the present invention is to provide a level having a light connected to an end of the frame engaging the bubble vial so that the position of the bubble in the bubble vial can be seen by using the light bulb.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a level of the present invention;

FIG. 2 is a plan view to show the level of the present invention, and

FIG. 3 is a perspective view to show the level of the present invention.

### DETAILED DESCRIPTION OF THE PREFERRED EMBODIMENT

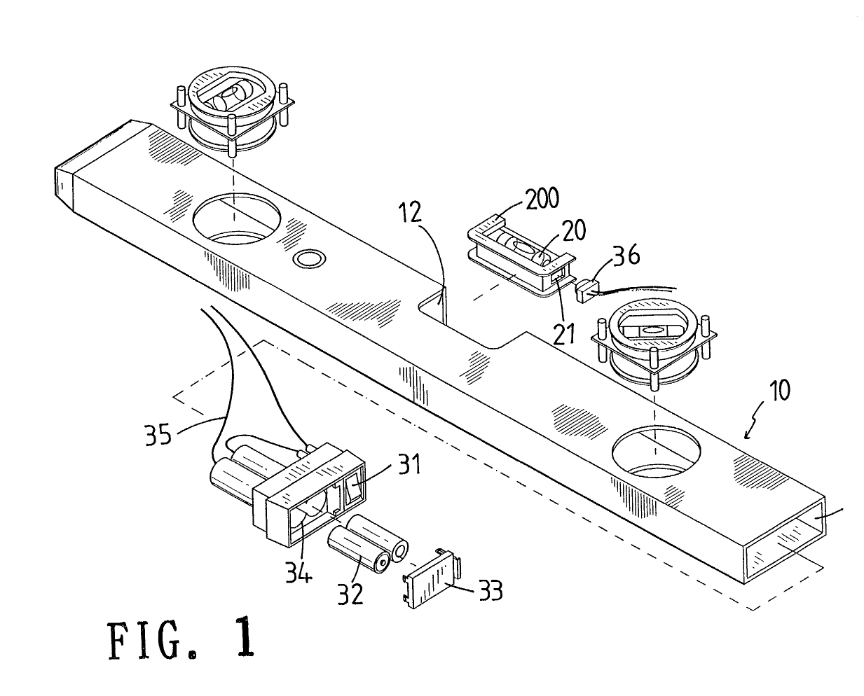

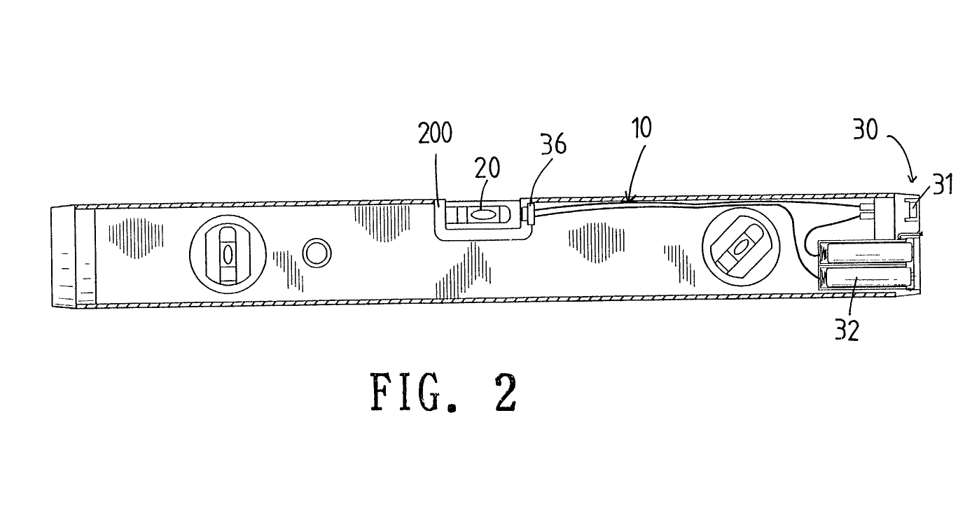

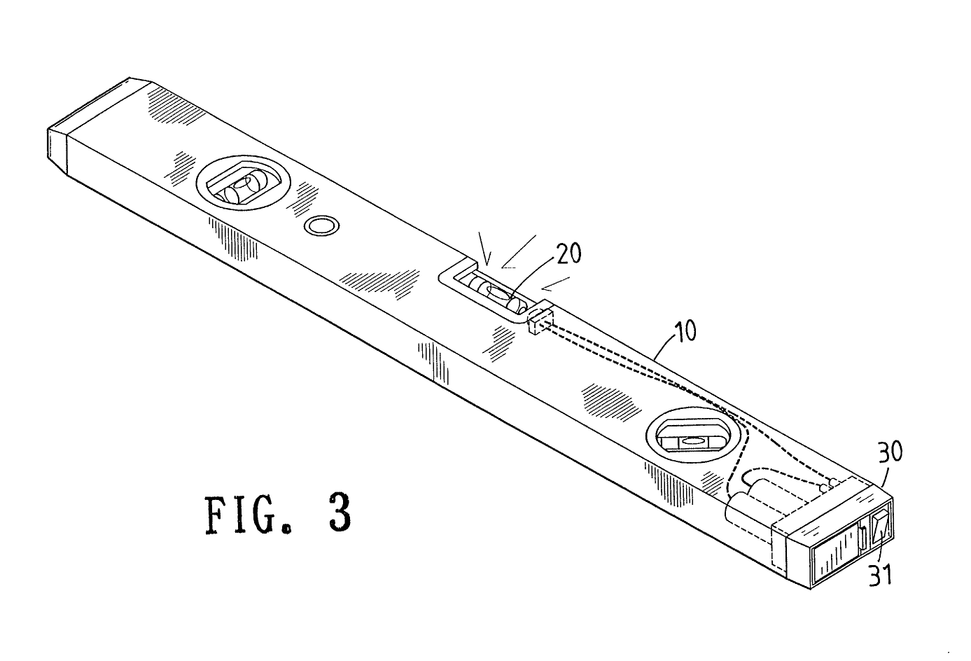

Referring to FIGS. 1 to 3, the level of the present invention comprises a body 10 having an open end 11 and a power supply assembly 30 is engaged with the open end 11. A recess 12 is defined in a side of the body 10 and a bubble vial assembly is engaged with the recess 12. The bubble vial assembly includes a bubble vial 20 engaged with a frame 200 which is engaged with the recess 12. An aperture 21 is defined in an end of the frame 200 and a light bulb 36 is engaged with the aperture 21 of the frame 200. The light bulb 36 is electrically connected to the power supply assembly 30 by wires 35 which are received in the body 10.

A switch 31 is connected to an end of the power supply assembly 30 and is accessed by users from the end of the body 10. Two battery recesses 34 are defined in the power supply assembly 30 and two batteries 32 are received in the battery recesses 34. A cap 33 is engaged with the power supply assembly 30 to close the battery recesses 34.

While we have shown and described the embodiment in accordance with the present invention, it should be clear to those skilled in the art that further embodiments may be made without departing from the scope of the present invention.

What is claimed is:

1. A level comprising:
a body having an open end and a power supply assembly engaged with said open end;
a bubble vial having a frame which is connected to said body, a light bulb engaged with an end of said frame, said light bulb electrically connected to said power supply assembly.

2. The level as claimed in claim 1 further comprising a switch connected to an end of said power supply assembly.

3. The level as claimed in claim 1 further comprising two battery recesses defined in said power supply assembly and a cap engaged with said power supply assembly to close said battery recesses.
